(19) United States
(12) Patent Application Publication
(10) Pub. No.: US 2007/0024399 A1
(43) Pub. Date: Feb. 1, 2007

(54) Filters and antennas for microwaves and millimetre waves, based on open-loop resonators and planar transmission lines

(75) Inventors: Juan Fernando Martin Antolin, Bellaterra (ES); Jorge Bonache Albacete, Bellaterra (ES); Ricardo Marques Sillero, Sevilla (ES); Juan Domingo Baena Doello, Sevilla (ES); Jesus Martel Villagran, Sevilla (ES); Francisco Medina Mena, Sevilla (ES); Francisco Falcone Lanas, Pamplona (ES); Jose Maria Lopetegui Beregana, Pamplona (ES); Miguel Beruete Diaz, Pamplona (ES); Mario Sorolla Ayza, Pamplona (ES)

Correspondence Address: WOLF, BLOCK, SHORR AND SOLIS-COHEN LLP, 250 PARK AVENUE, 10TH FLOOR, NEW YORK, NY, 10177, US

(73) Assignee: Universitat Autonoma de Barcelona, Bellaterra (ES)

(21) Appl. No.: 10/573,426

(22) PCT Filed: Sep. 22, 2004
(86) PCT No.: PCT/ES04/00414

§ 371 Date: Mar. 24, 2006

(30) Foreign Application Priority Data
Sep. 25, 2003 (ES) P-200302282

(51) Int. Cl. H01P 1/203

(52) U.S. Cl. 333/205; 333/219

(57) ABSTRACT

Filter for microwaves and millimetER waves, characterised in that it comprises a planar transmission medium (1) that it includes a conductor strip (3), metallic ground plane (4) and dielectric substrate (2) and in that it includes at least one split rings resonator (5a, 5b, 5c, 5d, 5e and 5f)

### TECHNICAL FIELD OF THE INVENTION

This invention relates to microwave and millimeter-wave filters and antennas based on split rings resonators and planar transmission lines.

### BACKGROUND OF THE INVENTION

Known in the art are periodic structures based on split rings resonators for the synthesis of band-rejection frequency responses and for achieving focalisation of electromagnetic waves propagating in space. Said structures are based on the fact that in the neighbourhood of the resonance frequency such rings can behave as an effective medium with extreme permeability values (positive beneath the resonance and negative above it). To achieve this said structures have to be irradiated with the magnetic field polarised parallel to the axis of the rings. This arrangement inhibits the propagation of electromagnetic signals in a narrow frequency band around the resonance frequency, thereby achieving a band-rejection response.

Also known are periodic structures based on split rings resonators for the synthesis of band-pass responses. In this case, in addition to the rings an additional superimposed structure is required that is capable of providing a negative value of the effective permittivity of the medium up to frequency values above the resonance frequency of the split rings resonators. In the region in which negative values coexist for the effective permeability and permittivity, signal propagation will thus be possible, and a band-pass response will therefore be obtained, resulting in a transmission medium in which the phase velocity and group velocity are anti-parallel (left-handed material). Among such structures we might cite those based on split rings resonators and metallic posts placed in alternate rows. Said metallic posts emulate a plasma scaled at microwave and millimeter-wave frequencies, lending the medium a negative permittivity value up to a frequency (plasma frequency) that depends on the radial dimensions of the posts and their separation. Structures have also been proposed that are based on split rings resonators embedded in a rectangular wave guide, which also emulates a microwave plasma up to the cut-off frequency of the guide.

Moreover, these structures behave like electrical or magnetic current elements that enable antenna-like emission and reception of electromagnetic waves. By means of a periodic arrangement of such structures, the emission or reception of radiation can be observed experimentally, thanks to the structure permitting the propagation of fast waves.

One limitation on the practical utilisation of the above structures as filters, antennas, etc., lies in the fact that they are not compatible with circuit manufacturing technologies (printed circuits or microelectronic technologies), since they are three-dimensional structures.

Another major limitation on the aforesaid structures relates to the fact that they present highly significant pass-band losses, making them unviable for use as filters and antennas. Such losses are due not so much to radiation or to ohmic or dielectric losses, but are rather the consequence of lack of adaptation between the medium and the measuring probes.

Structures are known that are based on planar transmission lines in which negative effective permeability and permittivity values coexist within a certain frequency range, though they are never resonant structures, nor are split rings resonators used in such structures for obtaining narrow band-rejection or band-pass responses.

### SUMMARY OF THE INVENTION

The objective of this invention is to resolve the aforementioned disadvantages relating to the structures based on split rings resonators, by developing a filter based on a planar transmission medium that can act as a single band-pass and band-rejection filter or antenna or groupings thereof that operate at microwave and millimeter-wave frequencies and are compatible with planar circuit-manufacturing technologies and with modern micro-machining techniques.

In accordance with this objective, the filter for microwaves and millimetric waves of this invention is characterised in that it includes a planar transmission medium that includes a conductor strip, metallic ground plane and dielectric substrate and in that it includes at least one split rings resonator.

These characteristic means that very small-dimension filters can be made, due to the dimensions of the split rings resonators being much smaller than the signal wavelength at the resonance frequency of the open rings.

Moreover, said filters present low insertion losses in the pass band, their design is very simple and their manufacturing process is compatible with printed- and integrated-circuit manufacturing technologies.

They also present a high frequency selectivity as a consequence of the high quality factor of split rings resonators.

Preferably, the split rings resonators are metallic and are mounted in magnetic coupling with the planar transmission medium.

Said split rings resonators include at least one pair of concentric metallic rings (same level) or else a pair of rings mounted one above the other, with openings at some point in them in order to achieve a resonant structure. Split rings resonators in a spiral configuration are also included.

In order to achieve a frequency response of the band-pass type filter, a type of periodicity has to be introduced into the planar transmission medium consisting in the metallic connections between the conductor strip and the metallic ground planes of said planar transmission medium.

According to another embodiment, the conductor strip is electrically separated from the metallic ground plane, behaving as a band-rejection filter. In this case, due to the fact that there is no connection between the conductor strip and the metallic ground planes, i.e. they are totally separated, the filter presents a band-rejection type of frequency response.

According to yet another embodiment, the split rings resonators of the last topology presented are metallic and are mounted in series with the conductor strip. The in-series insertion of several of the above-mentioned rings along the transmission line means that filters with a band-pass type of frequency response can be obtained, and with an unusually high impedance, except at the resonance frequency, where they become ‘transparent’ for electromagnetic propagation.

Preferably, the planar transmission medium is based on conventional transmission lines (coplanar, microstrip, stripline) or variants thereupon. Thanks to this characteristic, the filters can be implemented in any type of transmission line compatible with printed- or integrated-circuit technologies. The strip transmission line is known as ‘stripline’.

Alternatively, the split rings resonators are etched into the metallic ground plane, making their surface the negative of that of the metallic split rings resonators (complementary split rings resonators).

According to an embodiment corresponding to complementary split rings resonators, periodic capacitive gaps exist in the conductor strip, with the structure behaving as a band-pass filter.

According to another embodiment for the complementary split rings resonators, the conductor strip exhibits continuity, behaving as a band-rejection filter. In this case, the fact that there are no capacitive gaps in the conductor strip, i.e. that there is continuity throughout the entire conductor strip, means that the filter shows a band-rejection type of frequency response.

According to another embodiment, for the complementary split rings resonators of the latest topology shown, the conductor strip presents continuity, behaving as a band-pass filter. Only in this case, due to the fact that there are no capacitive gaps in the conductor strip of the last split rings configuration, i.e. that continuity exists throughout the conductor strip, the filter shows a band-pass type of frequency response.

According to another embodiment, the filter includes metallic split rings resonators in magnetic coupling with the planar transmission medium and complementary split rings resonators etched in the metallic ground plane, thus providing a band-pass response.

Additionally, the open rings are of circular or polyhedral geometry and present a plurality of metallic elements and/or openings etched into one or more levels of metal.

The combination of all these characteristics of the open rings allows a resonant structure to be achieved over a wide frequency margin.

Advantageously, the filter presents multiple pass- or rejection-bands, with bandwidth controllable by means of the number of openings and/or the arrangement of the split rings resonators and/or their geometry.

Advantageously, the filter is electronically reconfigurable and has built-in microelectromechanical switches (MEMS).

Additionally, an antenna for microwaves or millimeter waves can be implemented according to any of the preceding embodiments.

The fact that the radiation diagrams show good levels of directivity and polarisation means that the filter can behave as an antenna, since it eliminates the incident waves by radiating them. Variants can also be implemented based on groupings of batteries of antennas. Suitable adjustment of the ring properties allows emphasis of the radiation properties of said structures, permitting their use for the emission and reception of electromagnetic waves.

### BRIEF DESCRIPTION OF THE DRAWINGS

For a better understanding of all that has been set out some drawings are attached that show, schematically and solely by way of non-restrictive example, a preferred embodiment of the planar transmission medium and several ring resonator topologies.

FIG. 1 shows a perspective view of a planar transmission medium consisting in a buried coplanar wave guide (i.e., with dielectric substrate above and below the conducting strip and the mass planes).

FIG. 2 shows some topologies of split rings resonators, in spiral and in series configuration.

FIG. 3 shows the topology of a preferred embodiment for a band-pass filter with three stages of ring resonators implemented by means of a buried coplanar wave guide (i.e. surrounded by dielectric substrate above and below), with the rings etched in the outer faces of the dielectric substrate, and with narrow metallic attachments between the central conducting strip and the ground planes of the coplanar wave guides situated at the same level of the rings.

FIG. 4 shows a diagram of the measured frequency response of the filter of the invention corresponding to the preferred embodiment, and FIG. 5 shows a typical radiation diagram of the structures claimed in this invention.

### DETAILED DESCRIPTION OF THE INVENTION

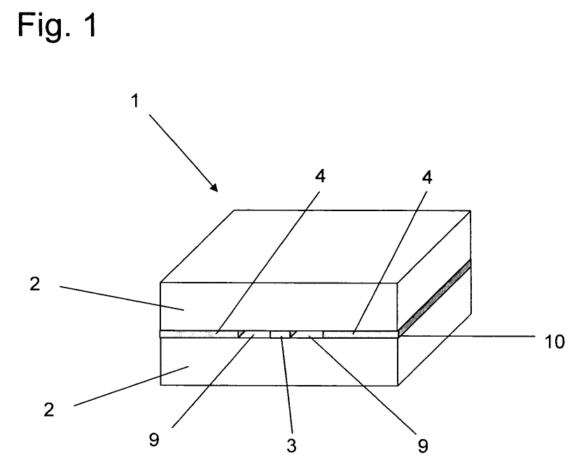

FIG. 1 of this invention shows a planar transmission medium 1 structure of the buried coplanar wave guide type, i.e., with dielectric substrate 2 on both sides of the central metallic plane 10 on which the conductor strip 3 is formed, separated from the metallic ground planes 4 by the slots 9. Alternatively, the coplanar wave guide can consist of the same structure as that shown in FIG. 1, though with dielectric substrate 2 only on one of the sides of the central metallic plane 10, which contains the central conductor and the metallic ground planes 4. Or any other type of configuration with multiple layers of dielectric substrate 2. Other media of propagation are also possible, such as microstrip lines, striplines, and in general any planar transmission medium.

For the embodiment of high-performance filters and antennas it is advisable to use dielectric substrates 2 with low dielectric losses in order to obtain frequency responses with the lowest possible losses in the pass band 13 of the above-mentioned filters and antennas.

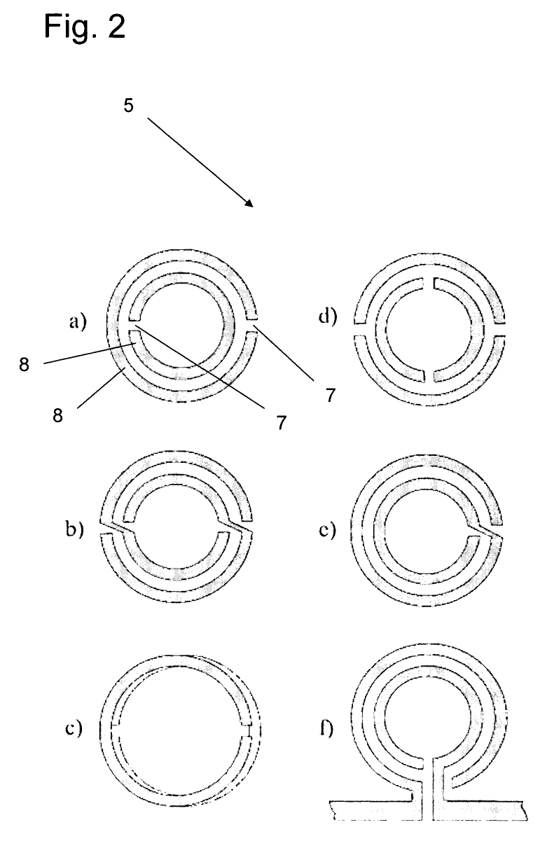

FIG. 2 shows some examples of the split rings resonators 5, which are characterised in presenting two open metallic rings 8, i.e. ones with slits 7 at some point in them.

Topology 5a comprises two open concentric metallic rings 8 each with one slit 7, with such slits 7 at 180° from each other.

Topology 5b comprises two open concentric metallic rings 8 each with two slits 7 arranged at 180° from each other, with said slits 7 made in the same position and with one end of the open metallic ring 8 being attached to the opposite end of the other.

Topology 5c comprises two superimposed open metallic rings 8 in different planes, each of them with one slit 7, with said slits 7 set at 180 ° .

Topology 5d comprises two open concentric metallic rings 8, each of them with two slits 7 set at 180° from each other, with the slits 7 of one ring being arranged at 90° in relation to those of the other.

Topology 5e comprises two open concentric metallic rings 8 in a spiral, each of them with one opening 7, with said openings 7 being arranged at the same position and with one end of the open metallic ring 8 being attached to the opposite end of the other.

Topology 5f comprises two symmetrical open concentric metallic rings 8, each of them with one slit 7, with said slits 7 being arranged at the same position and mounted in series with the conducting strip 3.

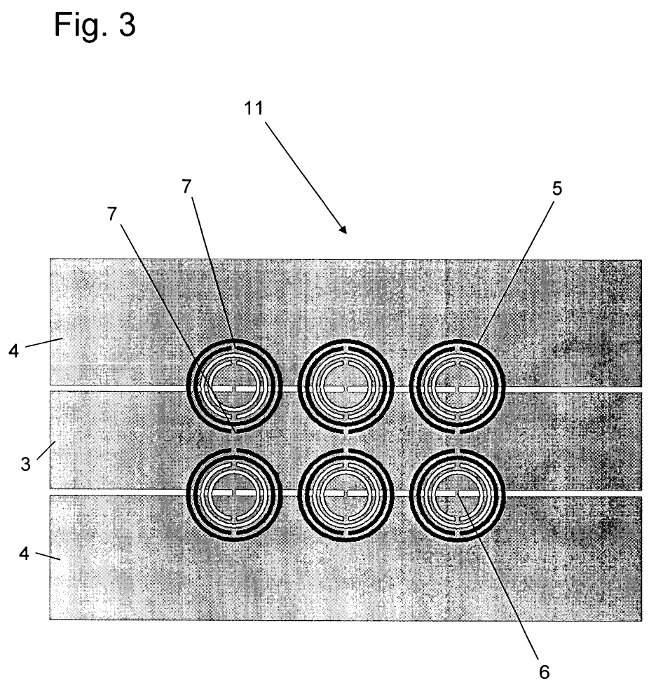

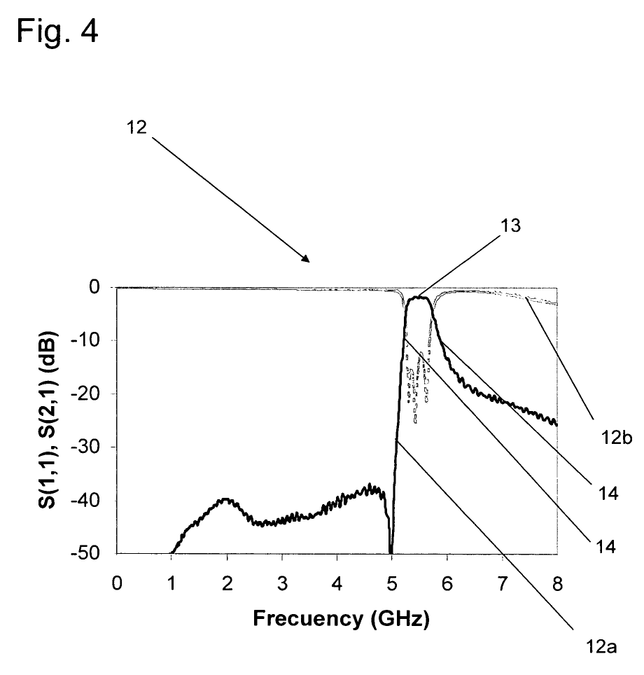

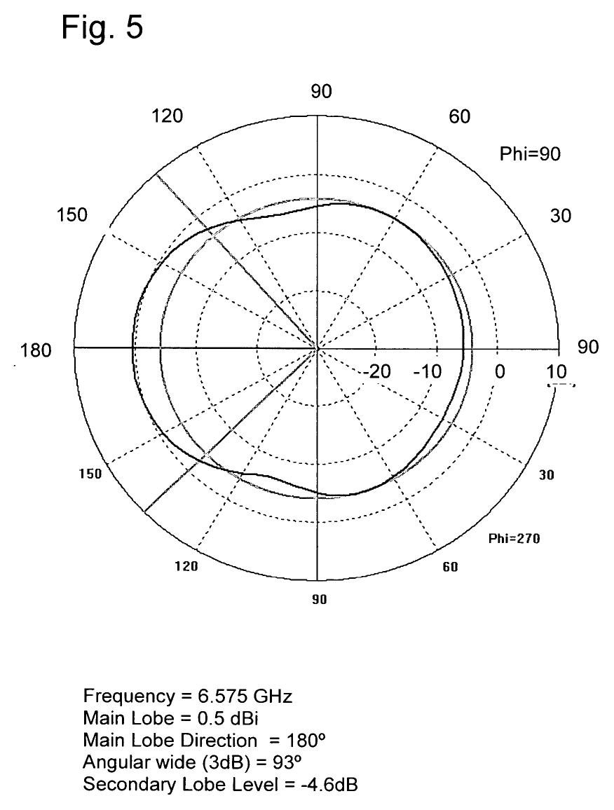

FIG. 3 shows the topology of a filter 11 with buried coplanar wave guide structure and based on metallic split rings resonators 5, with slits 7 on opposite sides, and etched in the outer faces of the dielectric substrate 2. In this topology, which provides a band-pass type frequency response, narrow metallic connections 6 can be seen between the conductor strip 3 and the metallic ground planes 4. The design of the filter 11, with band-pass type response, is based on the fact that the metallic connections 6 between the conductor strip 3 and the metallic ground planes 4 confer a plasma-type behaviour on the structure up to a frequency (plasma frequency) which is controlled by the width of the aforesaid metallic connections 6 and the separation between them, and which must exceed the resonance frequency of the split rings resonators 5a, 5b, 5c, 5d and 5e. Up to said plasma frequency the metallic connections 6 provide the propagation medium with a negative-value effective permittivity. Moreover, the design of the filter 11 is based on the dimensions of the split rings resonators 5a, 5b, 5c, 5d and 5e, including the separation between them and their width, which does not need to be identical on each open ring 8 of the split rings resonator 5a, 5b, 5c, 5d and 5e. Said dimensions determine the resonance frequency value of the split rings resonator 5a, 5b, 5c, 5d and 5e, which controls the position of the pass band 13 of the filter 11, which starts at the resonance frequency of the split rings resonator 5a, 5b, 5c, 5d and 5e. Being in magnetic coupling with the propagation medium, the split rings resonators 5a, 5b, 5c, 5d and 5e lend the propagation medium a negative value of the effective permeability within a narrow frequency region, extending the pass band 13 of the filter 11 in that region in which negative values of effective permittivity and permeability coexist.

The filter 11 can also be implemented using other split rings resonator 5 topologies and with different types of geometries of such split rings resonators 5 (round, square, and polyhedral in general) . The filter 11 can also be embodied by means of complementary split rings

1. Filter for microwaves and millimeter waves comprising, a planar transmission medium (1) which includes a conductor strip (3), metallic ground plane (4) and dielectric substrate (2) and in that it includes at least one split rings resonator (5a, 5b, 5c, 5d, 5e and 5f).

2. Filter according to claim 1, wherein said split rings resonators (5a, 5b, 5c, 5d and 5e) are metallic and are mounted in magnetic coupling with the planar transmission medium.

3. Filter according to claim 2, further comprising metallic connections(6) between the conductor strip (3) and the metallic ground plane (4), behaving as a band-pass filter.

4. Filter according to claim 2, wherein said conductor strip (3) is electrically separated from the metallic ground plane (4), behaving like a band-rejection filter.

5. Filter according to claim 1, wherein said split rings resonators (5f) are metallic and are mounted in series with the conducting strip (3).

6. Filter according to claim 1, wherein said planar transmission medium (1) is based on conventional transmission lines (coplanar, microstrip, stripline) or variants thereof.

7. Filter according to claim 1, wherein split rings resonators (5a, 5b, 5c, 5d, 5e and 5f) are etched in the metallic ground plane (4), making their surface the negative of that of the metallic split rings resonators (5a, 5b, 5c, 5d, 5e and 5f).

8. Filter according to claim 7, wherein for the split rings resonators (5a, 5b, 5c, 5d and 5e) capacitive gaps exist in the conductor strip (3), behaving as a band-pass filter.

9. Filter according to claim 7, wherein for the split rings resonators (5a, 5b, 5c, 5d and 5e), the conductor strip (3) shows continuity, behaving as a band-rejection filter.

10. Filter according to claim 7, wherein for the split rings resonators (5f), the conductor strip (3) shows continuity, behaving as a band-pass filter.

11. Filter according to claim 1, wherein said metallic split rings resonators (5a, 5b, 5c, 5d and 5e) in magnetic coupling with the planar transmission medium (1) and split rings resonators (5a, 5b, 5c, 5d, 5e) etched in the metallic ground plane (4).

12. Filter according to claim 1, wherein said open rings (8) are of circular or polyhedral geometry and present a plurality of metallic elements and/or slits (7) etched into one or more levels of metal.

13. Filter according to claim 1, wherein it presents multiple pass- (13) or rejection-bands, with band width controllable by means of the number of slits (7) and/or the arrangement of the split rings resonators (5a, 5b, 5c, 5d, 5e and 5f) and/or their geometry.

14. Filter according to claim 1, wherein it is electronically reconfigurable and has built-in microelectromechanical switches (MEMS).

15. Antenna for microwaves and millimeter waves that includes at least one filter according to claim 1.
